(19) United States
(12) Patent Application Publication
(10) Pub. No.: US 2006/0029090 A1
(43) Pub. Date: Feb. 9, 2006

(54) Method and system for distributing wireless communication signals in an HFC network

(76) Inventor: Angelo Bione, Lawrenceville, GA (US)

Correspondence Address: ARRIS INTERNATIONAL, INC, 3871 LAKEFIELD DRIVE, SUWANEE, GA, 30024, US

(21) Appl. No.: 11/194,166

(22) Filed: Aug. 1, 2005

Related U.S. Application Data
(60) Provisional application No. 60/598,862, filed on Aug. 4, 2004.

(51) Int. Cl. H04J 3/22; H04J 3/16; H04L 12/56; H04L 12/28; H04L 12/66; H04B 7/00

(52) U.S. Cl. 370/419; 370/310; 370/469

(57) ABSTRACT

Wireless interface nodes couple to a wireless protocol controller over an HFC network. The wireless controller, located at the head end, interfaces the CMTS with the HFC. Thus, a conversion between standard packets and wireless protocol packets occurs; packets are transmitted/received at standard HFC frequencies to/from the wireless interface nodes. The wireless nodes upconvert downstream signals to a wireless frequency and transmit same from an antenna. Upstream signals received from wireless user devices at wireless frequencies are downconverted at the wireless node to HFC upstream frequencies. When downstream packet signals from the head end are detected, upstream signal processing at the node is disabled. If this results in loss of preamble bits, additional preamble bits may be added at the head end. Upstream processing may be disabled unless upstream packets are present. DOCSIS in-band signaling may be used to communicate control information between the head end and the wireless nodes.

### CROSS REFERENCE TO RELATED APPLICATION

This application claims priority under 35 U.S.C. 119(e) to U.S. provisional patent application No. 60/598,862 entitled “Distribution of Wimax or wireless signaling in a HFC network,” which was filed Aug. 4, 2004, and is incorporated herein by reference in its entirety.

### FIELD OF THE INVENTION

This invention relates, generally, to communication networks and devices and, more particularly, to integrating wireless communication systems and devices into traditional wire-based communication network systems.

### BACKGROUND

Data-Over-Cable Service Interface Specifications (“DOCSIS”) has been established by cable television network operators to facilitate transporting data traffic, primarily internet traffic, over existing community antenna television (“CATV”) networks. In addition to transporting data traffic as well as television content signals over a CATV network, multiple services operators (“MSO”) also use their CATV network infrastructure for carrying voice, video on demand (“VoD”) and video conferencing traffic signals, among other types.

In transporting downstream multimedia content, as well as data, an upstream message, or messages, is/are typically sent to request the content and to set up a service flow to deliver the content. In addition to downstream multimedia content, such as video, voice traffic also uses message signaling to set up service flows for the upstream and downstream directions.

These signals are typically sent over a fiber network to a location, sometimes referred to as a node, near an end user, and from the node to a broadband user's device via a coaxial cable. Such an arrangement is known in the art as a hybrid fiber coaxial network (“HFC”).

However, due to cost considerations, many MSOs have not extended the coaxial portion of their networks to some locations, i.e., rural locations with low population densities. Therefore, many consumers who are desirous of services that require connection to a broadband network, are often out of luck. In addition to rural consumers and businesses, people who move their residence frequently, are often faced with canceling service subscriptions, including to broadband services, and setting up new subscriptions when moving from a old location to a new location.

Thus, there is a need in the art for a method and system for providing connectivity to a broadband network without having to connect equipment to a wired network.

### BRIEF DESCRIPTION OF DRAWINGS

FIG. 1 illustrates a system for providing wireless services over an HFC network.

FIG. 2 illustrates components included in the HFC-wireless nodes.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

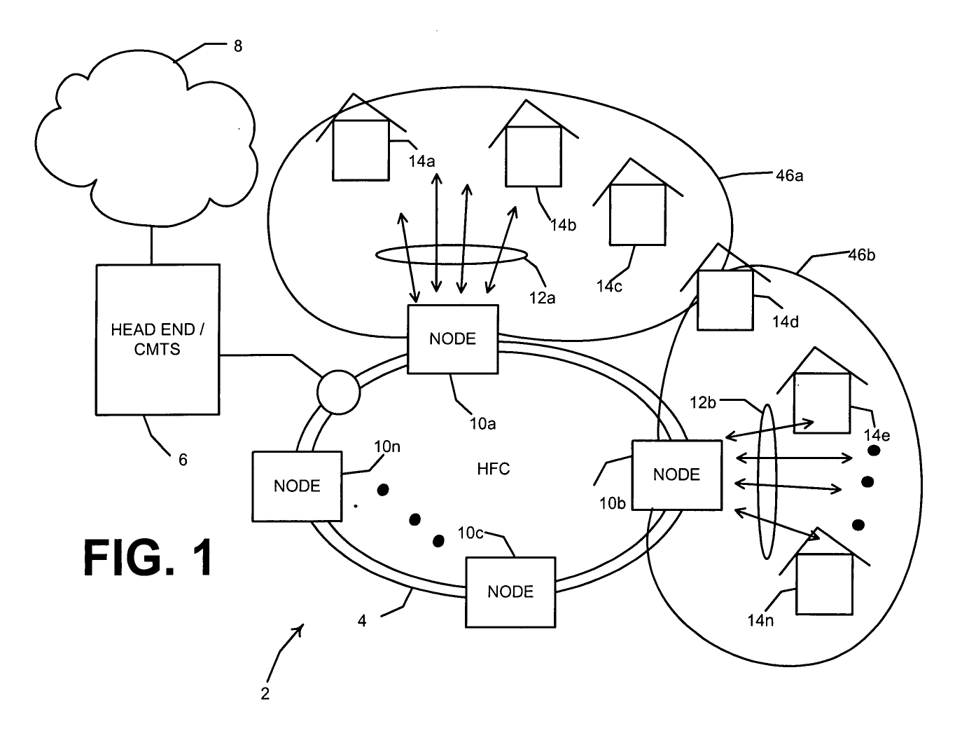

Turning to the figures, FIG. 1 illustrates a system 2 for providing wireless delivery and distribution of services over an HFC network 4. Content information signals, including voice, data and/or video signals, for example, are interfaced between head end 6 and content network 8. Such network(s) 8 include, for example, plain old telephone service (“POTS”), internet and/or cable television. It will be appreciated that these network types are given for purposes of example only; network(s) 8 may include these and/or other types as well.

A conventional HFC network environment is often configured to transmit data traffic using the DOCSIS protocol, for example, as well as voice and video traffic. The signals that carry the information corresponding to these traffic types between the head end and the end users are typically encoded into MPEG-2 transport packets as known in the art. A cable modem termination system (“CMTS”) located at the head end 6 typically performs switching and routing functionality. At the head end 6 are also modulators and demodulators, upconverters, filters, etc. that provide an interface for the MPEG-2 transport packets to/from the radio frequency (“RF”) used for transport on the HFC.

These typically MPEG-2 signals are converted between the wireless domain and the wired-RF domain at wireless interface nodes 10, which contain transmit and receive components to provide an interface between the RF signals on HFC 4 and wireless antennas at the nodes. Nodes 10 may be strand mounted, pedestal mounted or mounted in a pole housing. The antennas transmit and receive signals 12 that are respectively received and transmitted wirelessly at one or more user devices 14. It will be appreciated that the user devices 14 may be stationary wireless devices installed in a user's home or office, or may be mobile devices, depending on the standardized wireless protocol used.

Thus, the advantage is provided that separate CMTS switching and routing components need not be installed at each node 10. Rather, a single CMTS can be installed at head end 6. The CMTS components at head end 6 are coupled with a wireless protocol controller at the head end, wherein the wireless protocol is, for example, WiMax. The wireless controller supports the particular wireless protocol being used, such as WiMax, and couples with circuitry for modulating/demodulating the wireless protocol signals for transport/receipt on the HFC. The modulation scheme is preferably quadrature amplitude modulation with orthogonal frequency division multiplexing, commonly referred to in the art as OFDM.

The wireless controller supports the wireless protocol by transforming standard packets to conform to the wireless protocol. This typically includes adding header bits to the packets that contain control information for use by various components during transmission between head end 6 and wireless users 14. Other circuitry that may be included in the controller may, for example, filter signals, apply noise suppression techniques and toggle between upstream and downstream operation. Thus, system 2 facilitates communicating signals between the wireless protocol controller and the various nodes 10 using one channel in the downstream direction and one channel in the upstream direction.

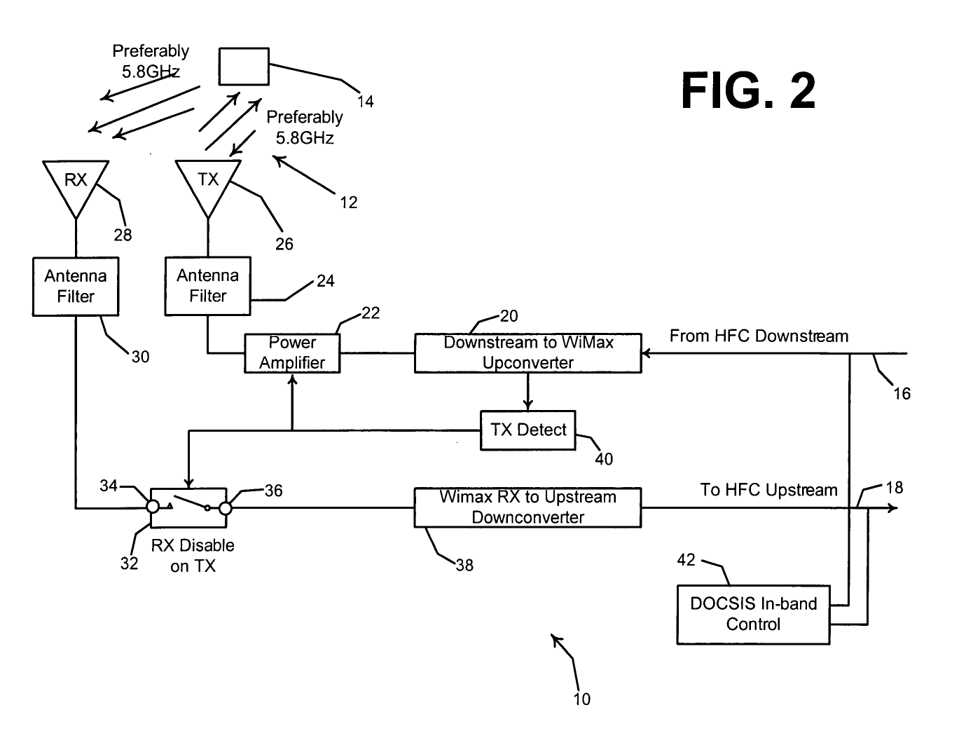

Turning now to FIG. 2, a block diagram illustrating some of the components included in the various nodes 10 is shown. As discussed above, a downstream traffic channel 16 and an upstream traffic channel 18 are provided to node 10. It will be appreciated that channels 16 and 18 may propagate over separate cables, or the same cable, since they are typically operating a different frequencies. The two lines shown in FIG. 2, and in the representation of network 4 in FIG. 1, are provided to illustrate two channels, but not necessarily two different physical lines/conductors. Different channels are provided because an HFC plant typically operates in the upstream direction and the downstream direction typically at different frequencies. However, many wireless protocols, including, for example, WiMax, operate at the same frequency in the upstream and downstream direction. Therefore, wireless protocol traffic packets received from the head end on channel 16 are converted to the wireless operating frequency by upconverter 20. The modulated wireless protocol packet signals are fed to power amplifier 22, which boosts the signal strength. From amplifier 22, the traffic signals are fed through filter 24 before being provided to transmit antenna 26, which broadcasts the downstream signal to wireless user devices 14 that are tuned to the wireless operating frequency signals 12.

In the upstream direction, i.e., a user is sending information toward the head end, wireless signals from a user device are received at receive antenna 28 and filtered at filter circuitry 30. If receive disabler 32 is configured to provide a path between points 34 and 36, the upstream traffic signal(s) are fed to upstream downconverter 38. Downconverter 38 converts the received upstream signal from the wireless operational frequency to the HFC upstream frequency according to the frequency from which the CMTS has configured the downconverter. Similar to the process when a cable modem boots up, known in the art as ranging and registering, the CMTS instructs the frequency agile downconverter 38 which upstream frequency it (the CMTS) is set to receive upstream signals on the upstream channel. A similar process is performed with respect to upconverter 20.

Returning to the discussion of signal flow through disabler 32, if the receive disabler is not configured to provide a path between points 34 and 36, the upstream signals are blocked from reaching upstream downconverter 38. Receive disabler 32 may be configured to block upstream signals from reaching upstream downconverter 38 if a disable signal from transmit detector 40 is present. If transmit detector 40 detects that a traffic signal is present at upconverter 20, the detector generates a disable signal instructing disabler 32 to block upstream traffic. This prevents downstream signals from being transmitted from antenna 26, only to be received by antenna 28 and sent back to the head end, which would result in an undesirable feedback condition. Disabler 32 may be a switch, a relay, a semiconductor, or means known in the art for controllably enabling/disabling an electrical signal path. DOCSIS in-band controller 42 may be used to transmit control signals between the head end and the nodes.

When in response to the presence of downstream traffic signals disabler 32 outputs a disable signal to isolate signals present at point 34, a few preamble bits may be lost due to response time of the disabler. These preamble bits are part of the wireless protocol, and typically compose a repeating bit pattern sequence. Since the bit pattern sequence is known by the wireless protocol controller—the controller generates the preamble bits—the controller can generate extra copies of the repeating sequence and add them to the preamble. Software, hardware, or other means known in the art for conditioning/modifying packets may perform this function. Thus, if bits are lost there are still enough of the sequence patterns to impart the appropriate information to wireless device(s) 14 when the downstream signal packets are received thereby.

Another feature not shown in the drawing is a receive detect circuit that detects when an upstream signal has been received receive antenna 28. The receive detect circuit can work in concert with disabler 32, which may be designed to default to the disable configuration (path between points 34 and 36 is broken). Thus, logic that operates disabler 32 would ensure that only if an upstream signal is received at antenna 28 is the path between points 34 and 36 made up. This prevents noise that is 5 received at antenna 28 from being continuously placed into the upstream channel 18 when in fact there is no actual upstream traffic being received. As discussed above, disabler 32 will be in the disabled state if downstream traffic signals are detected by detector 40.

Thus, a single wireless controller located at the head end is coupled to multiple wireless nodes via an HFC network, so that separate controllers at each node location are not needed. This wireless controller may be inserted in place of a CMTS blade in a modular CMTS, such as, for example, a C4™ as sole by ARRIS® International, Inc. It will be appreciated that installation of the wireless controller may displace a CMTS blade, but since the C4™ system is scalable and flexible, revenue generated by additional wireless subscribers should offset the cost of scaling upgrades. In addition, a C3™ CMTS, also marketed by ARRIS®, can be outfitted with a wireless controller to operate as described above. Additional C3® CMTS components may be added as needed at the head end to accommodate future scaling needs.

The beam patterns 46, as shown in FIG. 1, may be adjusted to accommodate subscriber locations, and to prevent overlap of beam patterns of transmitters operating at different frequencies. Beams 46a and 46b are shown in the figure with minimal beam overlap. Minimizing overlap is desirable if upstream signals corresponding to each beam are operating at the same frequency and the same upstream channels 18, as shown in FIG. 2. If this condition exists, it is possible that different user devices 14 assigned to the same upstream channels 18 may transmit signals on the proper channel, but the corresponding downstream channel may be different than in the other zone. This could cause communication to fail, since the CMTS would be receiving upstream traffic on the proper channel, but could not send downstream traffic to the same device 14.

If overlap of beam patterns cannot be cannot be eliminated, and multiple users assigned to different downstream channels are located within the same beam pattern, or zone, then reception from antennas having overlapping zones may be alternatingly disabled so that erroneous reception of upstream traffic is not placed onto the HFC 4, as shown in FIG. 1. DOCSIS messaging can be communicated between the head end and DOCSIS in-band control module 42 to communicate beam forming and zone disable messages/signals.

An advantage of using the HFC cable plant as the backhaul between the wireless nodes and the head end is that AC power is carried on the HFC, so a dedicated power supply is not needed for each node 10. Thus, each node may be powered from the HFC.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A system for interfacing one or more wireless communication devices with central network communication equipment at a head end over a hybrid fiber coaxial communication network, comprising:
At least one wireless interface node coupled to the hybrid fiber coaxial communication network for wirelessly interfacing said communication network with the one or more wireless devices; and
a wireless protocol controller for providing media access control functionality and physical layer functionality for interfacing central network equipment at the head end with the hybrid fiber coaxial communication network.

2. The system of claim 1 wherein the wireless interface node includes:
an upconverter for converting downstream signals from the hybrid fiber coaxial network to a frequency used by the wireless communication devices; and
a downconverter for converting signals received from the one or more wireless communication devices at the frequency used by the one or more wireless communication devices to an upstream frequency used by the hybrid fiber coaxial network.

3. The system of claim 1 further comprising means for detecting downstream signals to be transmitted toward the one or more wireless communication devices, said detecting means being operable to isolate the downconverter before the detected downstream signal is transmitted.

4. The system of claim 1 further comprising means for adding copies of preamble bits to a downstream packet to be transmitted.

5. The system of claim 1 wherein the wireless protocol controller includes modulation circuitry, and wherein the wireless protocol is WiMAX.

6. A method for communicating wireless protocol signals over a hybrid fiber coaxial communication network between a head end and a wireless interfaced node, comprising:
providing a downstream signal in a first digital communication format protocol from a cable modem termination system to a wireless controller;
converting the downstream signal from the digital communication format protocol to a second communication format protocol at the wireless controller;
transmitting the downstream signal in the second communication format protocol over the hybrid fiber coaxial communication network at a first downstream frequency;
receiving the downstream signal at the first downstream frequency at the wireless interface node;
upconverting the downstream signal from the first downstream frequency to a second downstream frequency at the wireless interface node; and
transmitting the downstream signal at the second downstream frequency from an antenna at the wireless interface node.

7. The method of claim 6 further comprising:
receiving an wireless protocol upstream signal at a first upstream frequency from a wireless user device with an antenna at the wireless interface node;
downconverting the wireless protocol upstream signal from the first upstream frequency to a second upstream frequency;
transmitting the wireless protocol upstream signal from the wireless interface node toward the head end over the hybrid fiber coaxial communication network;
receiving the wireless protocol upstream signal at the wireless controller;
converting the wireless protocol upstream signal into an upstream signal in the first digital communication format protocol; and
providing said upstream signal in the first digital communication format protocol to the cable modem termination system.

8. The method of claim 6 wherein the second communication format protocol is a wireless protocol.

9. The method of claim 8 wherein the wireless protocol is WiMAX.

10. The method of claim 6 wherein the first digital communication format protocol is MPEG2 transport.

11. The method of claim 6 wherein the first downstream frequency is between 42 MHz and 1 GHz.

12. The method of claim 6 wherein the second downstream frequency is 5.8 GHz.

13. The method of claim 7 wherein the second communication format protocol is a wireless protocol.

14. The method of claim 13 wherein the wireless protocol is WiMAX.

15. The method of claim 7 wherein the second upstream frequency is between 1 MHz and 42 MHz.

16. The method of claim 7 wherein the first upstream frequency is 5.8 GHz.

17. The method of claim 7 further comprising disabling upstream signal processing at the wireless interface node when a downstream signal has been received at the wireless interface node.

18. The method of claim 7 further comprising disabling upstream signal processing at the wireless interface node unless an upstream signal has been received from a wireless user device at the wireless interface node.
